(19) United States
(12) Patent Application Publication
(10) Pub. No.: US 2004/0115309 A1
(43) Pub. Date: Jun. 17, 2004

(54) Food supplement

(76) Inventor: Patricia Anna Harris, Leicestershire (GB)

Correspondence Address: FULBRIGHT & JAWORSKI, LLP, 1301 MCKINNEY, SUITE 5100, HOUSTON, TX, 77010-3095, US

(21) Appl. No.: 10/381,266

(22) PCT Filed: Sep. 21, 2001
(86) PCT No.: PCT/GB01/04230

(30) Foreign Application Priority Data
Sep. 22, 2000 (GB) 0023354.4
Jun. 29, 2001 (GB) 0116048.0

(51) Int. Cl. A23L 1/30

(52) U.S. Cl. 426/72

(57) ABSTRACT

The present invention provides a food supplement and methods for aiding in the prevention or treatment of a respiratory disease. The present invention further provides the foodstuff or food supplement as an ergogenic aid. The food or food supplement of the present invention comprises one or more antioxidant vitamins in combination with one or more of eugenol, selenium, a carotenoid, a flavenoid, a phyto-estrogen, a proanthrocyanidin, a herbal phenolic compound or ubiquinone.

This invention relates to a food supplement comprising one or more antioxidant vitamin in combination with one or more of eugenol, selenium, a carotenoid, a flavenoid, a phyto-estrogen, a proanthrocyanidin, a herbal phenolic compound or ubiquinone. The invention further relates to a foodstuff or a food supplement of the invention for use in medicine including aiding the prevention or treatment of oxidative damage especially in the respiratory tract. More preferably this invention relates to a foodstuff or a food supplement of the invention for use in aiding the prevention or treatment of a respiratory disease. The invention further relates to the use of the food or food supplement in the manufacture of a foodstuff for aiding the prevention or treatment of oxidative damage more preferably to aid in the prevention or treatment of a respiratory disease. The invention further relates to a method for aiding the prevention or treatment of oxidative damage including a method for aiding the prevention or treatment of a respiratory disease. A further application of the invention involves the administration of the foodstuff or food supplement as an ergogenic aid.

Oxidative damage is caused by the action of highly reactive species (such as free radicals or peroxides) on the cells and tissues of the body. A free radical is any atom or group of atoms, which has one or more unpaired electrons. Free radicals are uncharged high-energy species that are highly reactive. Peroxides are compounds containing linked pairs of oxygen atoms. Organic peroxides can act as sources of free radicals.

One major source of such reactive species is molecular oxygen, which is converted into a “reactive oxygen species”. The loss of an electron from molecular oxygen will produce a free radical species, which reacts with cells or tissue in the body causing damage including lipid peroxidation, which leads to cell death. Reactive oxygen species can be produced in the body of an aerobic organism during metabolism, for example by the respiratory burst of phagocytes, mitochondrial oxidative phosphorylation and the xanthine oxidase system. In addition, reactive oxygen species are produced in the environment, for example by UV light, pollutants or ionising radiation.

Agents causing oxidative damage can be inactivated by antioxidant molecules or compounds. Antioxidants are typically highly substituted phenols, aromatic amines or sulphur containing molecules, which can occur naturally or can be produced synthetically. In addition, metal-sequestering agents can act as antioxidants by inactivating metals. The body has its own anti-oxidant defences including glutathione, vitamin C, vitamin E, catalase, copper-zinc-superoxide dismutase and uric acid.

Exposure of the body to agents causing oxidative damage results in inflammation, auto immune diseases, cancers, muscle disorders, lung inflammation and general ageing. Oxidative damage to the respiratory tract is responsible for causing or exacerbating a number of respiratory disorders. Oxidative stress occurs when the production of reactive oxygen species exceeds the removal of the reactive oxygen species. The lung is highly susceptible to oxidative injury due to inhaled reactive oxygen species and exposure to the products of inflammatory cells located in the lungs.

Chronic obstructive pulmonary disease (COPD) is a chronic lung disease, which results in respiratory dysfunction. Prolonged or persistent respiration dysfunction produces a chronically reduced level of oxygen or a chronically elevated amount of carbon dioxide resulting in respiratory acidosis. This respiratory disease has been reported in humans, cats and dogs but is especially prevalent in horses. Symptoms of COPD in horses include decreased exercise tolerance, coughing, mucus hypersecretion, severe dyspnoea and disturbed oxidant/anti oxidant equilibrium.

COPD causes irreversible changes in the lungs including thickening of the bronchi and bronchioli and collapse of airways. Disturbances in gas exchange in the lung leads to a decrease in oxygen exchange.

The cause of COPD in horses is believed to multifactorial. COPD is comparatively rare in tropical or subtropical countries where horses are more commonly kept outside. It is generally believed that exposure to materials in a stable environment for instance dust, hay and straw dust, microscopic moulds such as Aspergillus fumigatus, Faenia rectivirgula and Thermoactinomyces vulgaris and irritating gases (such as ammonia from urine break down) may contribute to the development of the condition. Exposure to pollutants in the air and allergies to plant and tree pollen may also play a role in causing this problem in sensitive horses.

Treatment of COPD is purely palliative, as there is currently no cure. The management of COPD concentrates on preventing further attacks. This environmental management approach includes keeping the horse outside. Where a horse must be kept inside, good ventilation is essential in order to minimise exposure to dust, pollutants etc and the use of dustfree grains, appropriate bedding or moistening food before feeding helps to avoid further attacks. This approach is the most effective method of alleviating the symptoms of COPD but owner compliance is a problem.

In moderate or severe cases of COPD, it is necessary to treat the horse with prescription medication. Corticosteroids are used to reduce the inflammation of the airways thereby resolving the clinical signs of the disease. However, the airway inflammation will return following cessation of the therapy if the horse is exposed to offending antigens. The use of corticosteroids is accompanied by a number of undesirable side effects. High concentrations of the corticosteroids result in the suppression of the immune system. The long-term use of corticosteroids can lead to depression, muscle wasting, long dry hair coat, hyperglycemia, increased risk of laminitis, polydipsia and polyuria.

Therefore any treatment or therapy which decreases the concentration of corticosteroids necessary to treat COPD will be beneficial.

Bronchodilators have been used in respiratory diseases to remove airway obstruction in the lungs. There are three major classes of bronchodilators; anticholinergic agents, sympathomimetic agents and phosphodiesterase inhibitors.

Anticholinergic agents, such as atropine, act by blocking vagally induced bronchospasm, however side effects of the treatment include decreased mucociliary clearance, tachycardia, mydriasis, ileus and excitement.

Sympathomimetic agents stimulate β2 receptors in the large and small airways causing broncodilation. However the specificity of β2 agonists is not complete and side effects such as trembling, excitement, sweating, ileus, colic and tachycardia can occur as a result of inadvertent stimulation of β1 receptors.

Phosphodiesterase inhibitors inhibit the breakdown of intracellular cAMP in airway smooth muscle. The most commonly used phosphodiesterase inhibitor in horses is theophylline, which works effectively at blood concentrations of 10 μg/ml. However the therapeutic level (10 μg/ml blood concentration) and the toxic levels (15 μg/ml blood concentration) are close to each other making theophylline difficult to use clinically.

The use of mucolytics and expectorants may be useful in cases with excessive quantities of tenaceous mucus in the lower airways however, there is no information showing the efficacy of mucolytics in equine airway disease.

Mast cell-stabilising agents such as disodium cromglycate have been shown to be effective in prolylaxis of COPD in some horses. In clinical practise, however administration of disodium cromogycate has exhibited mixed results.

It has been suggested that immunotherapy may be helpful in some cases of COPD, producing hyposensitisation to offending allergens. However, the identification of the relevant allergens and the presence of multiple allergies in individual horses limit the effectiveness of this treatment.

The use of conventional drug therapies can be effective in the treatment of COPD. However these therapies are costly and can have some undesirable side effects. It is therefore proposed to find an adjunct treatment to respiratory disorders including COPD in horses. It is proposed that this therapy will decrease and in some cases alleviate the symptoms of COPD in horses. In addition, it is proposed that this therapy will reduce the reliance of a horse on conventional drug therapies.

Summer pasture associated obstructive pulmonary disorder (SPAOPD) exhibits similar clinicopathology to COPD. SPAOPD affects pastured horses, usually from spring to early autumn with complete remission in winter. Horses which suffer form SPAOPD in summer can also suffer from COPD in winter when they are housed in a stable.

Horses with SPAOPD show long term airway hyper-responsiveness. Pulmonary hypersensitivity may occur due to exposure to inhaled pollens or outdoor moulds or due to ingested plant-derived pneumotoxin.

Treatment of SPAOPD is similar to that used in the management of COPD. These treatments concentrate on the use of environmental management, bronchodilators, anti-inflammatory drugs (especially corticosteroids) and sodium cromglycate.

It is therefore proposed that the adjunct treatment of respiratory disorders will also decrease and in some cases alleviate the symptoms of SPAOPD in horses. It is also proposed that this therapy will reduce the reliance of a horse on conventional drug therapy.

Horses are usually kept in order to be worked and exercised; for example, horses are kept for recreational or competitive riding. During exercise the oxygen needs of active tissue in the body increases. At the same time, the extra carbon dioxide and heat produced by the body must be removed. To this end, the rate of respiration will increase. Further changes are required to the body,for example circulation must increase to the muscles while adequate circulation is maintained in the rest of the body.

During exercise, the energy requirement increases and ATP is hydrolysed to ADP and inorganic phosphate in order to meet this demand. Regeneration of ATP from ADP is facilitated by creatine phosphate. Creatine phosphate itself is resynthesised using energy derived from the oxidation of carbohydrates, fats and proteins within the mitochondria.

If the resynthesis of creatine phosphate becomes limiting then there will be a build up of ADP and a reduced power output. During intense exercise, when muscle phosphocreatine stores are becoming limited, ADP accumulation starts. Increased levels of ADP trigger the myokinase reaction in which two molecules of ADP form one molecule of AMP. The AMP is further deaminated to IMP and metabolised via inosine, hypoxanthine, and xanthine to uric acid. The decline in muscle ATP is mirrored by the postexercise appearance of the end products of this pathway including uric acid into the plasma of the horse. These processes are associated with the onset of fatigue. IMP can be reaminated to AMP especially at the onset of recovery. Degradation of IMP to uric acid is one of several routes by which highly reactive free radicals are formed and which during exercise may challenge the anti-oxidant defences. Other free radicals will be produced through increased rates of metabolism and respiration.

Thus, it is proposed to provide a means of lessening the oxidative stress produced by exercise. The reduction in oxidative stress should allow a horse to recover more quickly from the exercise thus improving the welfare of the horse.

Free radicals are produced in the environment by ozone, UV light or sources of ionising radiation. Exposure to these forms of free radicals occurs daily as a result of normal day to day living. Exposure is greater in cities or industrial areas where the levels of pollution are high. It is therefore proposed to provide a means of protection against environmental free radical exposure.

The first aspect of the invention comprises a food supplement comprising one or more antioxidant vitamin in combination with one or more of eugenol, selenium, a carotenoid, a flavenoid, a phyto-oestrogen, a proanthrocyanidin, a herbal phenolic compound or ubiquinone.

The antioxidant vitamins of the first aspect of the invention are compounds which can inactivate free radical species or the sources of free radicals including reactive oxygen species and hydrogen peroxide. Examples of such antioxidant vitamins include vitamin C, vitamin E and beta-carotene.

Vitamin C is a water-soluble substance. Vitamin C has a number of important roles in the body. It has an essential role in the maintenance of healthy teeth, gums and bones. It aids the healing of wounds, scar tissue and fractures and strengthens blood vessels. Vitamin C also builds resistance to infection and aids in the prevention and treatment of the common cold. Vitamin C is also one of the major antioxidant nutrients.

The food supplement of the first aspect of the invention will optionally contain vitamin C at a level of between 60 mg per kilogram body weight and 0.1 mg per kilogram body weight per day, more preferably 20 mg per kilogram body weight and 3 mg per kilogram body weight per day, most preferably 10 mg or above per kilogram body weight per day.

The vitamin C according to the first aspect of the invention may be in any form. It may be liquid, semi-solid or solid.

Vitamin E is a collective term for several biologically similar compounds, including those called tocopherols and tocotrienols, which share the same biological activity. The selenium-containing enzyme glutathione peroxidase together with vitamin E helps to protect cells against free radical induced damage. Vitamin E acts as a scavenger of free radicals. Vitamin C may assist by reducing the tocopheroxyl radicals formed by the scavenging. In addition, vitamin E helps to block lipid peroxidation and may also form an important part of the membrane structure due to its interaction with membrane phospholipids. It has also been suggested that Vitamin E plays an important role in the functioning of the immune system. The most biologically active biological form of vitamin E in animal tissue is alpha-tocopherol. Vitamin E cannot be synthesised in vivo. Forms of vitamin E for the present invention include D-alpha-tocopherol, D-alpha-tocopherol acetate, DL-alpha-tocopherol and DL-alpha-tocopherol acetate.

Units of vitamin E can be expressed as International Units (IU), where 1 IU of alpha-tocopherol approximates to 1 mg of alpha-tocopherol. Other vitamin E compounds have their IU determined by their biopotency in comparison to alpha-tocopherol as described in McDowell, L. R (1989) Vitamin E: In vitamins in Animal Nutrition, Chapter 4, page 96, Academic Press, UK.

Vitamin E is a major anti-oxidant nutrient and acts in the body as a free radical scavenger. Alpha-tocopherol is the most active anti-oxidant biological form of vitamin E.

The food supplement of the first aspect of the invention will optionally contain vitamin E at a level of between 20 IU per kilogram body weight and 1 IU per kilogram body weight per day, preferably between 10 IU per kilogram body weight and 3 IU per kilogram body weight per day, more preferably 5 IU or above per kilogram body weight per day.

A further useful point in relation to the use of vitamin E in combination with vitamin C is their potential to act synergistically. This may be assisted by the fact that vitamin E is lipid soluble and vitamin C is water-soluble. Alpha-tocopherol is known to sit in the lipid membrane. Ascorbate and alpha-tocopherol, for example, interact at the interface between cell membranes or lipoproteins and water. Ascorbic acid rapidly reduces alpha-tocopherol radicals in membranes to regenerate alpha-tocopherol.

Beta-carotene has strong antioxidant properties and has been shown to be beneficial against selected cancers, cardiovascular diseases, cataracts and age related macular degeneration. Beta-carotene is particularly effective at scavenging peroxyl radicals and is a very potent singlet oxygen quencher at low oxygen tensions. Supplementation of the diet with beta-carotene has been reported to reduce lipid peroxidation.

The food supplement of the first aspect of the invention will optionally contain beta-carotene as a level of from 10 mg per kilogram body weight to 0.001 mg per kilogram body weight per day, preferably 0.4 mg per kilogram body weight to 0.05 mg per kilogram body weight per day, more preferably 0.3 mg per kilogram body weight or above per day.

The antioxidant vitamins (including sources of such vitamins, such as beta-carotene) of the first aspect of the invention are provided in combination with one or more compounds, which exhibit antioxidant or anti-inflammatory properties. These compounds include eugenol, selenium, carotenoids, flavenoids, phyto-oestrogens, proanthrocyanidins, herbal phenolic compounds or ubiquinone.

The food supplement of the first aspect of the invention optionally provides a source of eugenol. Eugenol is a naturally occurring aromatic hydrocarbon. It is the active ingredient of spices such as cloves (Osmium spp.), garlic and nutmeg. Eugenol has been shown to possess hepatoprotective properties and its administration results in reduced levels of lipid peroxides in vivo. In addition, eugenol has been shown to protect erythrocytes against free radical damage and eugenol exhibits antioxidant properties.

Eugenol is provided at levels of between 15 mg per kilogram body weight and 0.001 mg per kilogram body weight per day, preferably at levels of between 1 mg per kilogram body weight and 0.01 mg per kilogram body weight per day, more preferably 0.1 mg per kilogram body weight per day or above.

The food supplement of the first aspect of the invention optionally provides selenium. Selenium is a trace element that functions as a co-factor in the body, specifically as a cofactor within antioxidant metalloenzyme systems. For example, selenium is an essential part of the antioxidant selenoenzyme, glutathione peroxidase. Selenium acts as an antioxidant (with activity as a free radical scavenger) and has been shown to act in combination with vitamin E. It has now been shown that glutathione levels in horses with COPD, are reduced. Therefore selenium supplementation is of added benefit.

The food supplement of the first aspect of the invention may provide selenium at a level of from 0.001 mg per kilogram body weight to 0.01 mg per kilogram body weight per day, more preferably from 0.006 mg per kilogram body weight to 0.001 mg per kilogram body weight per day, preferably 0.002 mg or above per kilogram body weight per day.

The food supplement of the first aspect of the invention optionally comprises one or more carotenoids. The carotenoids are a group of red, orange and yellow pigments predominately found in plant foods, particularly fruit and vegetables, and in the tissues of animals which eat the plants. They are lipophilic compounds. Some carotenoids act as a precursor of vitamin A, some cannot. This property is unrelated to their antioxidant activity. Carotenoids can act as powerful antioxidants. Carotenoids are absorbed in varying degrees by different animal species. Carotenoids may be classified into two main groups; those based on carotenes and those based on Xanthophylls (which include oxygenated compounds). Common carotenoids include beta-carotene, alpha carotene, lycopene lutein, zeaxanthin and astaxanthin.

The food supplement of the first aspect of the invention optionally contains one or more flavenoids. Flavenoids are found in many plant sources including fruits, vegetables and herbs. They have been reported to have multiple biological effects including their ability to act as antioxidants. Most of the biological roles played by the flavenoids are associated with their transition metal binding capabilities (i.e. iron and copper). Selected flavenoids have been found to have a much higher antioxidant activity than the commonly known antioxidants such as vitamin C or vitamin E. Examples of flavenoids include quercetin, ellagic acid, myricetin and gossypol.

The food supplement of the first aspect of the invention optionally contains one or more phytoestrogens. Phytoestrogens are naturally occurring compounds found in many plants. They are structurally and functionally similar to oestrodiol or produce oestrogenic effects. Phytoestrogens include lignans, isoflavones, counestans and resorcylic acid lactones. These compounds have been reported to possess antioxidant, anticarcinogenic, bactericidal, anti-viral, anti-inflammatory and antihypertensive activities. Sources of phytoestrogens include soya.

The food supplement of the first aspect of the invention optionally contains one or more of proanthrocyanidins. Proanthrocyanidins are potent antioxidant compounds, which in addition to protecting tissue from oxidative injuries can prevent cardiovascular diseases by counteracting the effects of high cholesterol.

The food supplement of the first aspect of the invention optionally provides a source of herbal phenolic compounds. Herbal phenolic compounds are naturally occurring compounds found in plants, especially herbs. The compounds are aromatic hydrocarbons, which exhibit antioxidant properties.

The food supplement of the first aspect of the invention optionally contains ubiquinone (also known as co-enzyme Q). Ubiquinone is a co-enzyme that is involved in the formation of ATP in the body. The co-enzyme is a quinone derivative that has anti-oxidant activity. Natural sources of ubiquinone include green leafy vegetables. Ubiquinone is believed to be non-toxic. It is thought that the coenzyme interacts with vitamin E to regenerates its antioxidant form, thus the administration of vitamin E and ubiquinone may provide a synergistic effect. Ubiquinone is believed to stabilise mitochondrial membranes and to help detoxify oxygen free radicals.

Ubiquinone is provided in this aspect of the invention at a level of between 20 mg per kilogram body weight and 0.05 mg per kilogram bodyweight per day, more preferably at a level of between 2 mg per kilogram bodyweight and 0.3 mg per kilogram bodyweight per day and most preferably of 0.5 mg or above per kilogram bodyweight per day

The food supplement of the first aspect of the invention may additionally one or more B vitamins. Preferably, the B vitamins include one or more selected from vitamin B-2 (riboflavin), vitamin B-6 (pyridoxine), vitamin B-1 (thiamine), vitamin B-12 (cobalamin), vitamin B-3 (niacin), pantotheic acid and folate.

Vitamin B-1 (thiamine) is involved in metabolism. It aids the digestion of carbohydrates allowing the generation of energy. Thiamine is essential for the normal functioning of the nervous system, muscles and heart.

Vitamin B-2 (riboflavin) is necessary for carbohydrate, fat and protein metabolism and maintains cell respiration. It aids in the formation of antibodies and red blood cells. It is necessary for the maintenance of good vision, skin, hair and nails and alleviates eye fatigue.

Vitamin B-6 (pyridoxine) is necessary for the synthesis and breakdown of amino acids and aids in fat and carbohydrate metabolism. It maintains the central nervous system and aids in the formation of antibodies. Vitamin B-6 has been shown to promote healthy skin and reduce muscle spasms, leg cramps, hand numbness, nausea and stiffness of the hands.

Folate is necessary for both DNA and RNA synthesis. It is essential to the formation of red blood cells and aids amino acid metabolism. Folate is preferably provided at a level of between 0.5 mg per kilogram body weight to 0.001 mg per kilogram body weight per day more preferably a level of between 0.25 mg per kilogram body weight to 0.01 mg per kilogram body weight per day.

The food supplement of the first aspect of the invention can optionally include trace elements such as iron, calcium, magnesium, copper, zinc and manganese. Preferably, the food supplement of the first aspect of the invention optionally includes copper and zinc. Copper and zinc form an integral part of the antioxidant metalloenzyme Cu—Zn-superoxide dismutase, which converts superoxide free radical to hydrogen peroxide. This conversion represents the first line of defence against activated oxygen species.

The components of the first aspect of the invention including the antioxidant vitamins and the antioxidant compounds can be provided by a natural source, a synthetic source or a mixture of one or more natural sources and one or more synthetic sources. In a preferred aspect of the invention, a portion of the antioxidant vitamin is provided by a synthetic source and a portion of the antioxidant vitamin is provided by a natural source.

A synthetic source for the purpose of this invention provides the component (for example, the antioxidant vitamin) substantially free of any other material. The synthetic source of the component is more than 70% pure, preferably more than 85% pure, more preferably more than 95% pure. The synthetic source can be any material which has been prepared from available starting materials by a series of biochemical or chemical reactions. The product of these reactions can then be partially or fully purified. In addition, the component can be isolated from a natural source. The required component is removed from the other components of the natural source and purified until only the required component is present. The synthetic source can be provided alone or can be admixed with other components including other molecules with antioxidant properties, pharmaceutically acceptable excipients, stabilising agents, anti-caking agents, emulsifiers, etc. The synthetic source can be provided in combination with a carrier such as silica. The structure of the synthetic product may correspond exactly to the structure of the component in nature or it can be an analogue of that structure. The synthetic product may be provided in a form which can be modified in the body to produce one or more active components (e.g. by the hydrolysis of an ester, etc).

The antioxidant vitamins can be provided by a synthetic source. The structure of the synthetic product may correspond exactly to the structure of the vitamin C, vitamin E or beta-carotene as found in nature or it can be an analogue of those structures. The synthetic compound can be provided as a pure form of vitamin C, vitamin E or beta-carotene or can provide vitamin C, vitamin E or beta-carotene in combination with a pharmaceutically acceptable excipient, a stabilising agent, or any other mixing material. The synthetic substrate can be in the form of a powder, granule, pellet, tablet, capsule, liquid or semi solid form.

Vitamin C for the present invention can be obtained from a number of synthetic sources including crystalline ascorbic acid (optionally pure), ethylcellulose coated ascorbic acid, calcium phosphate salts of ascorbic acid, ascorbyl palmitate, stabilised ascorbyl palmitate, ascorbic acid-2-monophosphate salt or ascorbyl-2-monophosphate with small traces of the disphosphate salt and traces of the triphophate salt or calcium phosphate (Stay-C®). Preferably, the vitamin C is provided as Stay-C® or ascorbyl palmitate.

Vitamin E for the present invention can be provided by a number of synthetic sources. Preferably the Vitamin E is provided as DL-alpha-tocopherol or DL-alpha-tocopherol acetate.

A natural source for the purposes of this invention provides the required component in combination with one or more other compounds. Preferably, the required component is provided within its naturally occurring matrix. For example, where vitamin C is provided by unprocessed broccoli, the vitamin C is provided in combination with carbohydrates, fibre, proteins, lipids, chlorophyll and other plant materials. The natural source of the required component can be an extract or a derivative of a natural source (for example, a plant, animal or mineral). The isolated or partially isolated material may then be partially purified by one or more purification steps. Alternatively, the component may be provided as part of a raw and unprocessed material. The raw unprocessed material may be cooked and/or dried. Furthermore, the processed, partially processed or unprocessed material can be reconstituted in the form of a solid, semi-solid or liquid.

The antioxidant vitamins can be provided by a natural source. Vitamin C, vitamin E or beta-carotene can be provided by a natural source containing vitamin C, vitamin E and beta-carotene. Alternatively, each of vitamin C, vitamin E or beta-carotene can be provided by a different natural source. In addition, two or more of vitamin C, vitamin E or beta-carotene can be provided by a particular natural source.

The antioxidant vitamins can be provided by a natural source, preferably by plant material. For the purposes of this invention, the plant material can come from any part of a plant (for example, the leaf, root, stem, bark, bulb, fruit, flower or seed) and can be any combination of such parts. The plant material can be unprocessed, semi-processed or processed and can be provided as a solid, an extract, an oil, a powder, dried or in solution.

Preferably, beta-carotene is provided by one or more of maize meal, broccoli, spinach, carrots, squash, tomato meal, red palm oil, tomato powder or tomato pomace/pulp. A preferred source of vitamin E is extracted tocopherols. The tocopherols can be from red palm oil or grape seed oil. In a preferred embodiment of the invention, the natural source of vitamin E and beta-carotene is red palm oil.

More preferably, the natural source of the antioxidant vitamins is a member of the Brassica (cabbage) family or a leafy green vegetable such as spinach or a combination of both. The Brassica family, for the present invention includes broccoli, cabbage (including savoy cabbage, red cabbage and Chinese cabbage), cauliflower, brussel sprouts, kale (including curly kale) and chard. More preferably, the natural source is broccoli, curly kale and/or spinach.

Broccoli is a source of vitamin A, vitamin B-2, vitamin B-6, folate, vitamin C, calcium, potassium and selenium. For the purposes of this invention, the broccoli can be raw, semi-cooked or cooked. Methods of cooking broccoli include baking, steaming and boiling. The broccoli may be dried or partially dried. Any form of broccoli for example, raw, semi-cooked or cooked can be dried. Preferred forms of dried broccoli include those containing between 0 and 40% w/w water, or between 0 and 10%, or between 0 and 5%. All preferred features described above for broccoli can also be applied to other members of the Brassica family.

The addition of members of the Brassica family to the food supplement of the first aspect of the invention will provide additional antioxidant effects. The Brassica family contains important sulphur-containing phytochemicals, including glucosinolates and S-methyl-cysteine sulphoxide. The phytochemicals have antioxidant capacity and show beneficial effects as anti-cancer agents.

One embodiment of the invention involves a food supplement containing a level of dried broccoli from 5 mg to 50 mg per kilogram body weight per day, preferably the food supplement contains a level of 20 mg per kilogram body weight per day or above of dried broccoli or an equivalent amount of a semi-dried or fully hydrated form of broccoli.

Green leafy vegetables for the present invention include spinach (Spinacia oleracea). Spinach is high in fibre and contains vitamin A, vitamin B-2, folate, vitamin B-6, vitamin C, vitamin E, potassium and zinc. For the purposes of this invention, the spinach can be raw or cooked. Methods of cooking spinach include baking, steaming and boiling. The spinach can further be dried. Either raw or cooked spinach can be dried. Preferred forms of dried spinach include those containing between 0 and 40% w/w water, or between 0 and 10%, or between 0 and 5%.

One embodiment of the invention involves a food supplement containing a level of dried spinach from 5 mg to 50 mg per kilogram body weight per day, preferably the food supplement contains a level of 20 mg per kilogram body weight per day or above of dried spinach or an equivalent amount of a semi-dried or fully hydrated form of spinach.

The food supplement of the first aspect of the invention provides the antioxidant vitamins in combination with one or more of eugenol, selenium, a carotenoid, a flavenoid, a phytoestrogen, a proanthrocyanidin, a herbal phenolic compound or ubiquinone. The antioxidant compounds listed above can be provided by a natural source, a synthetic source or a mixture of one or more natural sources and one or more synthetic sources. In a preferred aspect of the invention, a portion of the antioxidant compound is provided by a natural source and a portion of the antioxidant compound is provided by a synthetic source. Definitions of the natural and synthetic sources as discussed for the antioxidant vitamins also apply to the antioxidant compounds.

The source of eugenol is not limiting and can include natural and synthetic sources. For the first aspect of the invention, eugenol may be provided by one or more of garlic, cloves, or nutmeg. Where eugenol is provided by garlic, it can be provided by the bulb or the shoot or a combination of the bulb and the shoot.

Garlic is a member of the Allium family. For the purposes of the present invention, garlic can be replaced by any member of the Allium family including onions, shallots, chives and leeks. Garlic has a number of beneficial characteristics. It is reported to be a hypotensive, diuretic, vasodilator, hypoglycaemic, anticarcinogenic agent, antibacterial agent, antiviral agent antiinflammatory agent and expectorant. It is also reputed to protect against strokes, coronary thrombosis, atherosclerosis and platelet aggregation.

The active agents of garlic are a family of sulphur containing compounds, the thioallyl compounds. These include alliin, allicin, alliinase, ajoene and vinyldithiins. The presence of these organosulphur compounds accounts for garlic's antioxidant properties.

Garlic according to the first aspect of the invention may be in any form. It may be dried, fresh, crushed, in solution, in oil, as a powder, liquid (either as a solution or as an oil) or semi-solid.

Dried garlic is provided at levels of between 30 mg per kilogram body weight and 1 mg per kilogram body weight per day, preferably at levels of between 20 mg per kilogram body weight and 2 mg per kilogram bodyweight per day, more preferably at levels of 2 mg per kilogram body weight per day and above or an equivalent amount of a semi-dried or fully hydrated form of garlic.

An alternative source of eugenol for the first aspect of the invention is nutmeg. Nutmegs are widely used in cooking due to their strong bitter warm aromatic taste. They contain eugenol, lignin, stearin, volatile oil, starch, gum and an acid substance. Oil of nutmeg is used medicinally to conceal the taste of various drugs and as a local stimulant to the gastro-intestinal tract.

Nutmeg according to the first aspect of the invention may be in any form. It may be dried, fresh, crushed, in solution, in oil, as a powder, liquid (either as a solution or as an oil) or semi-solid.

Dried nutmeg is provided at levels of between 30 mg per kilogram body weight and 1 mg per kilogram body weight per day, preferably at levels of between 20 mg per kilogram body weight and 2 mg per kilogram bodyweight per day, more preferably at levels of 2 mg per kilogram body weight per day and above or an equivalent amount of a semi-dried or fully hydrated form of nutmeg.

The first aspect of the invention may contain one or more flavenoids from natural and synthetic sources. The source of the flavenoid is not limiting. More preferably, the natural source of flavenoids is one or more of rosemary and liquorice.

Rosemary is a widely used culinary herb. The plant contains tannic acid, resin and a volatile oil, which contains Borneol, bornyl acetate and other esters and a camphor derivative. Oil of rosemary is used as a tonic, astringent, diaphoretic and stimulant.

Dried rosemary is provided at levels of between 30 mg per kilogram body weight and 1 mg per kilogram body weight per day, preferably at levels of between 20 mg per kilogram body weight and 2 mg per kilogram bodyweight per day, more preferably at levels of 2 mg per kilogram body weight per day and above or an equivalent amount of a semi-dried or fully hydrated form of rosemary.

Liquorice has been shown to contain active sponins including glycyrrhizin. These compounds have been reported to have liver-protective effects through their anti-free radical properties. Glycyrrhizin is converted into its aglycone by intestinal flora. Flavonoid aglycones are very bio-available.

For the purposes of this invention the liquorice may be dried or partially dried, in the form of a powder, in oil, liquid (either as a solution or as an oil), crushed, an extract, fresh or semi-solid. Preferred forms of dried liquorice include those containing between 0 and 40% w/w water or between 0 and 10% or between 0 and 5%. Dried liquorice is preferably provided at a level of 5 mg per kilogram body weight to 0.05 mg per kilogram bodyweight per day more preferably 1 mg per kilogram bodyweight per day or above.

The first aspect of the invention relates to a food supplement which may contain herbal phenolic compounds. The source of the herbal phenolic compounds is not limiting and can include natural and synthetic sources. The herbal phenolic compounds can be provided by a natural source such as a plant, more preferably a herb plant. The phenolic compounds can be provided by one herb or by a mixture of herbs, for example, one or more of rosemary, nutmeg, oregano, basil and coriander. For the purposes of this invention, any part of the herb plant can be used (for example, leaf, stem, bark, bulb, root, fruit, flower or seed). The herb material can be dried, semi-dried, fresh, crushed, in oil, in solution as a powder, liquid (as a solution or as an oil) or semi-solid.

Alternatively, the herbal phenolic compound is provided as an extract from a plant. The phenolic compound can be extracted and partially or fully purified from the herb.

Preferably the phenolic compounds are obtained from rosemary.

Several phenolic compounds extracted from Rosemary (and related family members such as oregano) have exhibited antioxidant effects. Phenolics from rosemary include carnosol, rosemanol, carnosic acid and rosemaridiphenol. These phenolic compounds may act as antioxidants, inhibit carcinogenesis or act as anti-inflammatory agents.

Rosemary according to the first aspect of the invention may be in any form. It may be dried, fresh, crushed, in solution, in oil, as a powder, liquid (either as a solution or as an oil) or semi-solid.

The first aspect of the invention relates to a food supplement, which may contain a further source of carotenoids. The source of carotenoids is not limiting and can include natural and synthetic sources. In particular, the preferred source is a natural source and includes; marigold meal and lucerne meal (sources of lutein); maize meal, tomato meal, red palm oil, tomato powder, tomato pomace/pulp (sources of beta-carotene and lycopene). Sources include oils high in carotenoid levels and pure manufactured carotenoids such as lutein, violaxanthin, cryptoxanthin, bixin, zeaxanthin, apo-EE (Apo-8-carotenic acid ethyl ester), canthaxanthin, citranaxanthin, achinenone, lycopene and capsanthin. More preferably, the source of the carotenoids is red palm oil.

The first aspect of the invention may optionally comprise proanthrocyanidins. The proanthrocyanidins of the present invention can be provided by natural or synthetic sources. The source of the proanthrocyanidins is not limiting. Preferably, the proanthrocyanidins are provided by grape seed oil.

The first aspect of the invention may optionally comprise ubiquinone. The source of ubiquinone is not limiting and can include natural or synthetic sources. Natural sources of ubiquinone include green leafy vegetables including spinach and members of the Brassica family.

The first aspect of the invention may further comprise a source of selenium, wherein the selenium is provided by a synthetic or a natural source. The source of the selenium is not limiting. Natural sources of selenium include members of the Brassica family, more preferably broccoli. An alternative natural source of selenium is selenium yeast. Synthetic sources of selenium include any salt or complex of selenium including any organoselenium molecules. Preferably, selenium is provided as sodium selenate.

The food supplement the first aspect of the invention optionally contains B-vitamins including folate. The B-vitamins can be provided by natural or synthetic sources. Definitions of natural and synthetic sources discussed in relation to the antioxidant vitamins also apply to this aspect of the invention. Natural sources of the B vitamins include Brewers yeast.

Brewers yeast is provided in the food supplement in this aspect of the invention at a level of between 50 mg per kilogram body weight and 5 mg per kilogram body weight per day, preferably at a level of 20 mg per kilogram body weight per day or above.

The B vitamins may alternatively be provided by plant material. The B vitamins may be provided by a member of the Brassica family (broccoli, cabbage (including savoy cabbage, red cabbage and Chinese cabbage), cauliflower, brussel sprouts, kale (including curly kale) and chard), more preferably broccoli, or a green leafy vegetable such as spinach. The plant material can be in any form as discussed above.

The food supplement of the first aspect of the invention can further comprise trace elements such as calcium, magnesium, copper, zinc and manganese. The trace elements can be provided by a synthetic or a natural source. Natural sources of such elements (for example potassium and calcium) include members of the Brassica family, more preferably broccoli. Zinc and potassium can be provided by green leafy vegetables such as spinach. Synthetic sources of the trace elements include any salt or complex of the metal including any organometallic molecules. Preferably zinc, copper, magnesium and manganese are provided as the chloride, carbonate or sulphate salts or as the organic chelate.

The food supplement of the first aspect of the invention can additionally contain ingredients, which enable the food supplement to be formulated in a particular form. For example, the food supplement can contain molasses or a molasses/oil mixture for example cane molasses with approximately 6% or above oil such as Molglo (eg. to bind the ingredients together or as a palatability agent) or, oat feed, wheat feed or another suitable filler ingredient (as a filler ingredient). The food supplement may also contain a fibre source such as grasses, sugar beet, soya hulls and oats, a fat source such as corn oil, soya oil, processed canola oil, coconut oil, palm oil or sunflower oil and/or a starch source such as cereals (eg. corn, barley, oats). Thus, the food supplement may be a food.

The food supplement of the first aspect of the invention can contain a combination of the components discussed above.

In a more preferred embodiment of the first aspect of the invention, the food supplement comprises:

a natural source of carotenoids including beta-carotene (for example red palm oil),

a natural source of phyto-oestrogens (for example one or more of broccoli and spinach),

a natural source of vitamin B including folate (for example, one or more of broccoli or spinach),

a synthetic source of folate,

a natural source of vitamin C (for example, one or more of broccoli or spinach),

a synthetic source of vitamin C (for example Stay-C)

a natural source of vitamin E (for example red palm oil),

a synthetic source of vitamin E (for example, alpha-tocopherol),

a natural source of eugenol (for example one or more of garlic or nutmeg),

a natural source of flavenoids (for example one or more of rosemary or liquorice),

a synthetic source of selenium (for example sodium selenate),

a natural source of proanthrociadins (for example grape seed oil),

a natural source of herbal phenolic compounds (for example rosemary).

In a most preferred embodiment of the first aspect of the invention, the food supplement comprises the following ingredients.

TABLE 1

| Ingredient | Percentage (by weight) |
|---|---|
| Oat or Wheat Feed | 60%-2% |
| Maize Gluten | 50%-2% |
| Soya Bean Hulls | 30%-2% |
| Brewers Yeast | 10%-1% |
| Dried Spinach | 10%-1% |
| Dried Broccoli | 10%-1% |
| Molasses | 10%-1% |
| Vitamin C | 12%-0.02% |
| Alpha Tocopherol Acetate | 4%-0.2% |
| Dried Garlic | 6%-0.05% |
| Dried Nutmeg | 6%-0.05% |
| Dried Rosemary | 6%-0.05% |
| Grape Seed Oil | 3%-0.05% |
| Ubiquinone | 4%-0.01% |
| Folic acid | 0.1%-0.0002% |
| Sodium Selenate | 0.02%-0.0002% |
| Liquorice | 1%-0% |
| Red Palm Oil | 10%-1% |

Alternatively the food supplement comprises the following ingredients.

TABLE 2

| Ingredient | Percentage (by weight) |
|---|---|
| Oat or Wheat Feed | 60%-2% |
| Maize Gluten | 50%-2% |
| Soya Bean Hulls | 30%-2% |
| Brewers Yeast | 10%-1% |
| Dried Spinach | 10%-1% |
| Dried Kale | 10%-1% |
| Molasses | 10%-1% |
| Vitamin C | 12%-0.02% |
| Alpha Tocopherol Acetate | 4%-0.2% |
| Dried Garlic | 6%-0.05% |
| Dried Nutmeg | 6%-0.05% |
| Dried Rosemary | 6%-0.05% |
| Grape Seed Oil | 3%-0.05% |
| Folic acid | 0.1-0.0002% |
| Sodium Selenite | 0.02-0.0002% |
| Red Palm Oil | 10%-1% |

The food supplement of the first aspect of the invention can be provided in varying quantities per day. For example, for an approximately 500 kg horse, the food supplement can be provided in quantities of between 4 kg per day and 100 g per day. Preferably, the food supplement would be provided in quantities of 750 g to 150 g per day, more preferably 200 g or above. The figures are pro rata for differently sized horses.

For example, the food supplement can be fed in quantities of between 800 g and 20 g per 100 kg bodyweight per day, preferably in quantities of 150 g to 30 g per 100 kg bodyweight per day, more preferably 50 g per 100 kg bodyweight per day or above.

Preferred quantities of the food supplement for a horse of a given bodyweight are set out below.

TABLE 3

| Bodyweight | Amount per day (g) |
|---|---|
| 300 kg | 150 |
| 400 kg | 200 |
| 500 kg | 250 |
| 600 kg | 300 |

The above tables 1 and 2 indicate the composition of a food supplement which would be provided in an amount of 250 g per day and would be fed to a horse of approximately 500 kg bodyweight. It should be appreciated that if the total amount of supplement was to be increased, this would be achieved by increasing the amount of filler ingredients, binders or fibre source while maintaining the absolute amounts of the other components. Conversely, if the total amount of food supplement was to be decreased, the amount of filler ingredients, binders or fibre source would be reduced, whilst maintaining the absolute amounts of the other components.

The three ingredients, oat feed, maize gluten and soya bean hulls will together typically provide between 20-91% of a supplement of 250 g or higher. However, for a low volume supplement the oat feed, maize gluten and soya bean hulls may together be provided at levels of approximately 20% or less of the supplement. For example, for a supplement of approximately 100 g per day, the total amount of oat feed, maize gluten and soya bean hulls may be approximately 6-10% of the supplement.

The food supplement of the first aspect of the invention can be solid, semi-solid or liquid for example the food supplement could be in the form of a powder, a pellet or a drink. The food supplement can be added to the food or administered prior to or after feeding. Typically, the supplement will be administered together with the standard foodstuff used. The mixing may occur when the foodstuff is prepared or packaged or may occur when the foodstuff is provided to the animal. The supplement may alternatively be supplied as a topping to the foodstuff. The food supplement can be in the form of a food snack or drink (for example, snack bars, biscuits, and sweet products). The drink may be aqueous or oil based.

The food supplement of the first aspect of the invention can be prepared using convention techniques.

In one embodiment of the first aspect of the invention, the food supplement is provided as a pellet. The ingredients of the food supplement are mixed together and the product mix is passed through a die plate containing several holes of a nominated size (for example from 4 mm to 16 mm, more preferably from 4 mm to 9 mm). Minimal heat is applied to the mixture prior to its entering the mixer to raise the temperature of the mixture to approximately 50° C. Temperatures of 95° C. have been used to raise the temperature of the mixture to the required temperature.

The food supplement can be provided as an extruded pellet. In this process, the mixture enters the extruder where it is heated. By forcing the product along the barrel of the extruder through a series of precision restrictors, the product is exposed to high temperatures and high pressures. The product emerges from the extruder through a shaped die where it expands as the pressure immediately falls to room pressure. The extruded material is then cut to the required length.

According to the second aspect of the invention there is provided a food supplement of the first aspect of the invention for use in achieving a health benefit. The health benefits may be for unhealthy or healthy animals. The use can be termed as “medicine” although this term does not necessarily mean that the food supplement is a licensed medicament subject to regulatory authorisation requirements. Thus the food supplement may be used in “medicine”. The food supplement may be used in aiding the prevention or treatment of oxidative damage. The food supplement may be used in aiding the prevention or treatment of an animal suffering from respiratory disease, for example where that disease involves inflammation of the respiratory tract. The food supplement of the first aspect of the invention may be for the simultaneous, sequential or separate use in aiding the treatment of an animal suffering from respiratory disease.

The food supplement of the first aspect is provided to support the health of an animal. The food supplement provides antioxidants which are important in maintaining or improving the natural defences of the lung. Thus, the food supplement can be used to maintain the optimum health of an animal. Where an animal is suffering from a respiratory disease, the food supplement can be used in combination with one or more conventional therapies. Administration of the foodstuff may result in an improvement of the symptoms or a slowing of the progression of respiratory disease.

For the purposes of this invention, the terms “aid” and “aiding” mean to decrease or alleviate the symptoms suffered by an animal especially the symptoms of a respiratory disease suffered by a horse. This aid may allow the reliance on a drug therapy to be reduced. Alternatively the animal may exhibit less symptoms or the severity of the symptoms may be reduced. The animal may exhibit an improved level of fitness or an improved level of well being.

The food supplement of the first aspect of the invention may be used in aiding the treatment of an animal suffering from chronic obstructive pulmonary disease. In particular the food supplement is used where the animal is equine. Equine animals for the purposes of this invention include horses, ponies, camels and donkeys. Other mammals include for example human, feline or canine.

Without limiting the present invention, there is some evidence that reactive oxygen species may have a role in respiratory disease. Work has indicated that horses suffering from recurrent airway obstruction demonstrate oxidative stress. The food supplement of the invention has provided a cocktail of antioxidant compounds derived from natural sources which decreases the level of inflammation in horses suffering from COPD. Reactive oxygen species have also been implicated in asthma and related conditions.

Administration of the food supplement of the first aspect of the invention to an animal will provide an increased level of compounds with antioxidant activity thus reducing oxidative stress to the lung. This will be particularly beneficial where an animal has been or will be or is subjected to an increase in exercise (for example before a competition) or where an animal is exposed to free radicals due to pollution. The food supplement may help in maintaining the healthy respiratory system of a horse by supporting or improving the natural defences of the lung.

It is understood that animals will already be consuming some level of antioxidants through their normal diet. The food supplement of the first aspect of the invention can be used to increase the level of antioxidants in animals such as horses, in particular for those in need (for example those suffering from respiratory diseases or undergoing exercise). The food supplement is administered to healthy horses in order to supplement their levels of antioxidant and to help protect them against oxidative injury. In addition, the food supplement can be administered to those animals whose diet is nutritionally deficient in order to provide antioxidant compounds, which are not provided by the diet.

As previously discussed, treatment of COPD in horses involves preventing further attacks by environmental management or the use of prescription medication which can be costly and involves the risk of unwanted side effects. Administration of the food supplement of the first aspect of the invention can reduce the need for prescription medication thereby decreasing the risk of side effects to that medication.

The second aspect of the invention provides a food supplement, which provides an effective prophylaxis or adjunct treatment for COPD in horses. The food supplement may be manufactured from natural sources and provides a more natural treatment for this condition.

A further aspect of the invention provides a food supplement, which provides a contribution to the effective prophylaxis or treatment of asthma. Administration of the food supplement of the invention to an individual suffering from asthma will decrease lung inflammation thus decreasing the severity of the symptoms.

In a third aspect of the invention, there is provided a food supplement containing vitamin C for use in medicine. In particular, the third aspect of the invention is for use as described according to the second aspect of the invention. It may be for use in the natural defence of the lungs in a horse (health defence), and for use in aiding in the prevention or the treatment of respiratory disorders in horses. In particular, the food supplement is for use in aiding the prevention or treatment of horses suffering from COPD.

All preferred features of the first aspect of the invention also apply to the second and third aspects of the invention, including levels and other details of vitamin C and other components. The food supplement according to the third aspect of the invention may comprise selenium, in accordance with the details and preferred features of the first and second aspects of the invention.

A fourth aspect of the invention provides the use of the food supplement of the first aspect of the invention for the manufacture of a food stuff to aid in the prevention or treatment oxidative damage. The oxidative damage may be concentrated in the respiratory tract. The fourth aspect of the current invention provides the use of the food supplement of the first aspect of the invention for the manufacture of a food stuff for aiding the prevention or treatment of an animal suffering from a respiratory disease. The respiratory disease may involve inflammation of the respiratory tract.

All preferred features of the first, second and third aspects of the invention also apply to the fourth aspect of the invention.

A fifth aspect of the current invention involves a method of contributing to the prophylaxis or treatment of an animal susceptible to or suffering from oxidative damage. The fifth aspect of the invention also relates to a method of contributing to the prophylaxis or treatment of an animal susceptible to or suffering from a respiratory disease. In particular this relates to a method of treatment where the respiratory disease involves an inflammation of the respiratory tract. However, it is clear that the method may have more general effects throughout the body. In each case, the method comprises administering to the animal a food supplement of the first aspect of the invention. The animal is preferably in need of the prophylaxis or treatment.

All preferred embodiments of the first, second, third and fourth aspects of the invention also apply to the fifth aspect of the invention.

The sixth aspect of the invention provides a food stuff comprising a food supplement of the first aspect of the invention.

The food stuff can be solid, semi-solid or liquid. It is preferably packaged. The packaging may be metal, plastic, paper or card. The amount of moisture in any product may influence the type of packaging, which can be used or is required.

The food stuff according to the present invention encompasses any product, which an animal consumes in its diet. Thus, the invention covers standard food products as well as food snacks (for example, snack bars, biscuits and sweet products).

The food stuff according to the sixth aspect of the invention may be for use in medicine. The food stuff may be used to aid in the prevention or treatment of oxidative damage. The oxidative damage of this aspect of the invention may be caused by exposure to pollutants, UV light or radiation. The oxidative damage may be concentrated in the respiratory tract. The food stuff may be used to aid in the prevention or treatment of an animal suffering from respiratory disease. The food stuff may be used where the respiratory disease is chronic obstructive pulmonary disorder.

The food stuff of the sixth aspect of the invention can be prepared using conventional techniques. In particular, one or more components of the food supplement are mixed with a conventional food stuff. The food stuff may then be cooked or chilled and further substances can be added.

The foodstuff of the sixth aspect of the invention may be a complete food (i.e. containing all necessary nutrients), a complementary food (which is fed with forage, salt and water), a semi-complementary food (which provides a portion of the necessary nutrients) or a supplementary food (which contains specified amounts of one or more nutrients).

All preferred embodiments of the first, second, third, fourth and fifth aspects of the invention also apply to the sixth aspect.

A seventh aspect of the invention provides the food supplement of the first aspect of the invention or food stuff of the sixth aspect of the invention for administration to an animal as an ergogenic aid. Preferably, for this aspect of the invention, the animal is equine.

An ergogenic aid is any factor, which can increase or improve work production. This could be an increase in speed or endurance or strength.

The seventh aspect of the invention further provides a method of improving or increasing the work production of an animal comprising administering the ergogenic aid as a food supplement of the first aspect of the invention or as a food stuff of the sixth aspect of the invention.

The invention further provides a food supplement of the first aspect of the invention or a food stuff of the sixth aspect of the invention for use in the preparation of an ergogenic aid.

Without limiting the invention it is proposed that the presence of anti-oxidants (vitamin C, vitamin E, selenium, zinc or ubiquinone) in the food supplement acts as a defence against oxidant-induced membrane injury in tissue. In particular it is proposed that vitamin E acts as the defence mechanism while vitamin C regenerates the membrane bound vitamin E. Vitamin A and beta-carotene accumulates in tissue membranes and it is believed that these free radical scavengers will react directly with the peroxyl free radicals generated during exercise and serve as additional lipid soluble anti-oxidants. And/or improved oxygen transport due to reduced inflammation within the lung may contribute to any ergogenic effect.

Preferred features of the first, second, third, fourth, fifth and sixth aspects of the invention will also apply to the seventh aspect.

The invention will now be described with reference to the following non limiting examples.

### EXAMPLE 1

Six horses suffering from COPD (3 mares and 3 geldings 16.2±2.4 yrs; 515±80 kg) were chosen for this study. The horses were in clinical remission from COPD and were fed and managed in such a way to limit respiratory challenge. The horses were trained to run on a high speed treadmill for 6 weeks prior to the study. At the end of this adaptation period the horses showed similar lactate and heart rate responses to an exercise bout.

The horses were fed the same basal diet (normal diet for all the research horses ) for a 6 week adaptation period whilst they were being trained to exercise on the high speed treadmill.

250 g of either the food supplement (A) or a oat hull pellet (B) was fed, in addition to the basal diet, during the feeding periods. The basal diet only was fed during the washout period. Those horses which received supplement A first were then, after the washout period, switched to B and vice versa. The same forage was used throughout.

Evaluations were carried out at rest and during exercise at the start of the study; at the end of the first and second feeding periods and after the washout period.

TABLE 4
Food supplement A

| | Percentage |
|---|---|
| Ingredient | (by weight) |
| Oat Feed | 56%-29% |
| Maize Gluten | 24%-15% |
| Soya Bean Hulls | 12%-8% |
| Brewers Yeast | 6%-4% |
| Dried Spinach | 6%-4% |
| Dried Broccoli | 6%-4% |
| Molasses | 6%-4% |
| Vitamin C | 5%-1% |
| Alpha Tocopherol | 3%-0.5% |
| Acetate | |
| Dried Garlic | 0.6%-0.2% |
| Dried Nutmeg | 0.6%-0.2% |
| Dried Rosemary | 0.6%-0.2% |
| Grape Seed Oil | 0.3%-0.1% |
| Ubiquinone | 0.3%-0.1% |
| Folic acid | 0.06%-0.02% |
| Sodium Selenate | 0.02%-0.002% |
| Red Palm Oil | 7%-3% |

The above ranges were used in a 250 g supplement fed to a horse of approximately 500 kg body weight.

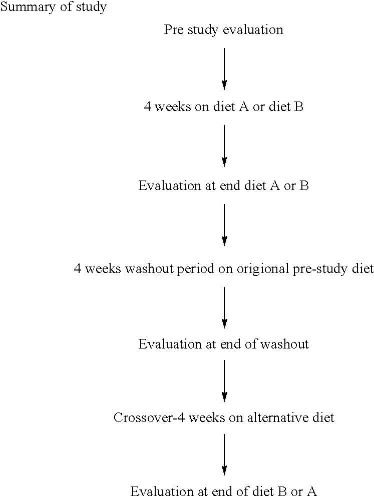

A number of evaluations were carried out on the horses at rest, including:

Haematology

Blood samples for Vitamin E and markers of systemic oxidative stress, Uric acid, MDA, isoprostanes, Glutathione (GSH, GSSG, TGSH, GRR), Vitamin E, total antioxidant status.

Arterial blood gases,

Mechanics of breathing,

Endoscopy and scoring of airway inflammation,

Bronchoalveloar lavage for cytology and pulmonary markers Uric acid; isoprostanes; glutathione (in pulmonary epithelial lining fluid).

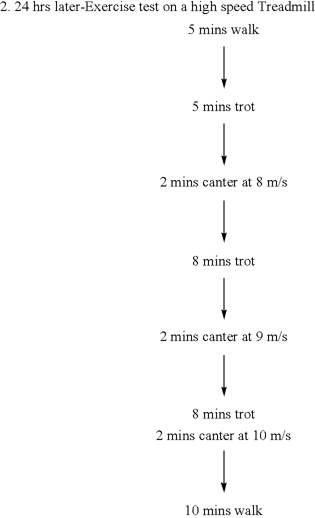

Walk and trot at 0% slope—canters all at 4%

Blood samples were taken at various points during and after the study via a jugular catheter for lactate, uric acid and total antioxidant status.

Heart rate was monitored consistently throughout the study.

Results

TABLE 5
Inflammatory score of the airways

| | Mean Post A | SD | Mean Post B | SD |
|---|---|---|---|---|
| General Score (1-12) | 3.67 | 0.52 | 4.33* | 0.82 |
| Where 1 denotes little and 12 | | | | |
| means severe | | | | |
| Oedema of the bronchial | 1.17 | 0.75 | 1.33 | 0.82 |
| carina (0-3) | | | | |
| hyperaemia of the | 0.83 | 0.75 | 1.17 | 0.75 |
| airways (0-3) | | | | |

A significant improvement in horses fed on food supplement A compared with oat hull pellet B was observed. This effect was observed in the inflammation of the airways, oedema of the bronchial carina and hyperaemia of the airways.

TABLE 6
Uric acid production post exercise

| | | | | | 15 min post | | 60 min post | |
|---|---|---|---|---|---|---|---|---|
| | Rest | | End 3^{rd} Canter | | exercise | | exercise | |
| | Mean | SD | Mean | SD | Mean | SD | Mean | SD |
| Post A | 6.42 | 1.43 | 11.64 | 5.6 | 15.88 | 11.8 | 10.88 | 7.4 |
| Post B | 6.91 | 1.22 | 15.18 | 7.3 | 30.29* | 16.2 | 18.57* | 9.1 |

Horses fed on food supplement A show a lower degree of uric acid production post exercise than the horses fed on the oat hull pellet B. Uric acid is a breakdown product of ADP. During intense exercise, the ADP accumulates triggering the formation of AMP. Further metabolism of AMP leads ultimately to uric acid which can be detected in the plasma of horses. The accumulation of such end products as uric acid are associated with the onset of fatigue.

Heart Rate

Horses fed on food supplement A showed a significantly reduced heart rate after the third gallop of the exercise treatment compared to horses fed on the oat hull pellet B.

A further study was carried out to investigate the effect of food supplement A. An additional two horses were added to the study and a more complete experimental protocol and results are provided below.

### EXAMPLE 1b

Eight horses (5 geldings, 3 mares, aged of 17.0±3.1 years, 513±63 kg bodyweight, mean±standard deviation (SD)) with a history of COPD were used in this study. All COPD-affected horses were in clinical remission after a two month period on pasture and were selected on base of a clinical examination and routine PFTs. The horses were maintained in clinical remission by bedding them on cardboard litter and feeding them grass silage. They did not receive any medical treatment during the study, which was approved by the Animal Ethics Committee of the University of Liege.

All horses underwent six weeks of controlled conditioning (3 times/week) on a high-speed treadmill (Equispeed, Versailles, Mich., USA) and were kept by individually adapted training in a stable fitness throughout the study.

After a six weeks period of treadmill exercise conditioning, the horses were randomly divided into two groups of four horses each. Group I was supplemented with food supplement A for four weeks, whilst group II was fed pellet B.

Two hundred fifty gram of either food supplement A or pellet B were fed once daily with one kg of wheat concentrate (molassed oats, pressed corn and pellets). The ingestion of the supplements was systematically verified.

After a wash-out period of four weeks, the treatments were inverted, i.e. group I was fed pellet B and group II was fed food supplement A for further four weeks. The effects of food supplement A and pellet B treatment on pulmonary function and oxidant stress were assessed on two consecutive days before and after each treatment period. On Day 1 (Rest: R), PFTs were performed, followed by blood samplings and BAL for analyses of both systemic and pulmonary uric acid, glutathione and 8-epi-PGF_{2α}. A differential cell count was performed on BAL fluid. On Day 2, twenty-two hours after the first BAL, the horses performed a SET on a treadmill for fifty minutes. Venous blood was sampled for analysis of uric acid, glutathione and 8-epi-PGF_{2α} at peak-exercise (Eₘₐₓ), and fifteen (E₁₅) and sixty (E₆₀) minutes after the end of the SET. Airway endoscopy followed by Bronchoalveolar lavage (BAL) was performed immediately after last blood sampling (E₆₀) and BAL uric acid, glutathione and 8-epi-PGF_{2α} were analysed. BAL was randomly performed in one lung side on Day 1 and in the other 24 hours later on Day 2.

Pulmonary Function Tests

Each horse underwent routine PFTs prior to admittance to the study (preliminary PFTs) and on Day 1 of the tests. The ventilatory mechanics measurement and the arterial blood gas tension analysis were systematically performed between 9:00 h and 10:00 h in order to reduce the possible influence of circadian rhythm of pulmonary parameters.

Ventilatory mechanics were measured for two minutes when the horse was breathing normally at rest. It required simultaneous pleural pressure and respiratory airflow measurements. Intrapleural pressure was measured by means of an oesophageal balloon catheter made from a condom sealed over the end of a polyethylene catheter (4 mm inner diameter, 6 mm outer diameter, 220 cm long, VEL, Leuven, Belgium) positioned with its tip in the middle thoracic oesophagus and connected to a pressure transducer (Valydine M1-45, Valydine Engineering, Northridge, Calif., USA). An airtight facemask covered horse's nostrils and mouth. The mask was shaped in order to minimise dead space and to avoid nasal compression. A Fleisch pneumotachograph Nr.4 mounted on the facemask was coupled by two identical catheters (4 mm inner diameter, 6 mm outer diameter, 220 cm long, VEL, Leuven, Belgium) to a differential pressure transducer (Valydine DP45-18, Valydine Engineering, Northridge, Calif., USA). Respiratory airflow and oesophageal pressure were simultaneously measured and dynamic compliance (C_{Dyn}), total pulmonary resistance (R_{L}) and maximal pleural pressure changes (MaxΔPpl) were continuously calculated on a breath-by-breath basis and recorded by a computerised system (Po—Ne-Mah, Gould Instrument Systems, Valley View, Ohio, USA). Volume and pressure calibrations were performed with a 2 L pump (Medisoft, Dinant, Belgium) and a water manometer, respectively.

Arterial blood was withdrawn anaerobically from the Arteria carotis communis and analysed, after correction for body temperature, for partial pressure in oxygen (PaO₂) and carbon dioxide (PaCO₂) (AVL 995, VEL, Leuven, Belgium).

No significant differences in C_{Dyn}, R_{L}, MaxPpl, PaO₂ and PaCO₂ between protocols were found suggesting no adverse effect of feeding supplement A.

Blood Sampling and Processing

Venous blood samples were collected on heparin tubes by jugular puncture on Day 1 and via a jugular catheter placed immediately before the SET on Day 2. All samples were immediately cooled on ice and processed within two minutes after collection. After centrifugation (10 min at 4° C., 900×g) plasma was aliquoted into 1 ml samples and snap frozen in liquid nitrogen for urea, uric acid and 8-epi-PGF_{2α} determinations. Centrifuged packed blood cells (0.5 mL) were carefully mixed with EDTA (2 mmol in 0.5 mL H₂O), snap frozen and stored in liquid nitrogen for glutathione analysis.

Airway Endoscopy and Bronchoalveolar Lavage Procedure

An endoscopic score of airway inflammation was systematically established by the same investigator. BAL fluid was immediately cooled on ice and processed. For urea and 8-epi-PGF_{2α}, aliquots of 5 mL untreated BAL fluid were stored at −80° C. Supernatant of centrifuged BAL (5 minutes, 2500×g, 4° C.) was snap frozen in liquid nitrogen and stored at −80° C. for uric acid analysis. For glutathione analysis, methanol was added to BAL (0.7 mL/mL BAL fluid) which was centrifuged for 2 minutes at 3000×g and 4° C. Supernatant was withdrawn, snap frozen and stored in liquid nitrogen. The remaining BAL fluid was fixed with ethanol (50%) for cytological analysis.

Standardised Exercise Test

The horses performed for fifty minutes a SET on a treadmill in a ventilated and air conditioned room (ambient temperature 18±3° C., relative humidity 55-60%). The SET consisted in a warm-up followed by three gallop steps which were interrupted by periods of trot. The SET was finished by a cool down walking. Exercise monitoring was performed at the end of each gallop step by telemetric heart rate recording (Life Scope Monitor, Nihon Kohden, Bretford, Middlesex, UK) and venous lactate determination (Accusport, Boehringer Mannheim, Mannheim, Germany). After the cool down walk, rectal temperature and venous packed cell volume (PCV) were measured.

Analysis of Blood Samples

All blood samples were analysed within two month following sampling. Plasma urea and uric acid were determined spectrophotometrically by the Sigma kit 66-20 BUN Endpoint and uric acid kit 685 (Sigma Diagnostics, St. Louis, USA), respectively. The haemolysate glutathione was analysed by high performance liquid chromatography (HPLC. Reduced glutathione (GSH), oxidised (GSSG) and total glutathione (TGSH=GSH+GSSG) were determined and glutathione redox ratio (GRR) was calculated (GRR=GSSG/TGSH). Plasma 8-epi-PGF_{2α} was analysed by an EIA kit (R&D Systems, Abingdon UK).

Analysis of Bronchoalveolar Lavage Fluid

All BAL samples were analysed within two month after the protocol. BAL urea was spectrophotometrically determined according to the method of Rennard et al (1986) by use of the Sigma kit 66-20 BUN Endpoint (Sigma Diagnostics, St Louis, USA). Uric acid was analysed by HPLC. GSH and GSSG in BAL were measured by use of HPLC and GRR was calculated. 8-Epi-PGF_{2α} in BAL was purified and concentrated (C₁₈ column, Bond Elut, Varian, Harbor City, Calif., USA) before being analysed by an EIA kit (Cayman, Abingdon, UK). Differential cell count of BAL cells was performed after centrifugation and Papanicolaou staining.

Statistical Analysis

Data are presented as mean±SD. Each variable of the four datasets corresponding to identical protocol time (Test I, II, III, IV) was analysed for time effect by a one-way analysis of variance. These analyses being non significant, datasets corresponding to identical feeding status were formed: A: before food supplement A or pellet B supplementation, B: after food supplement A supplementation, C: after wash-out, D: after pellet B supplementation. A was considered as pre-treatment reference for B and D in order to minimise baseline value variability. A was then compared with B and D by one-way analysis of variance for assessment of treatment-induced modifications. Comparisons were performed by considering separately each sampling time (R, Eₘₐₓ, E₁₅ and E₆₀) or by pooling them. Analysis of variance for repeated measures was performed within each dataset (intra-A, intra-B and intra-C) for analysis of exercise-induced modifications. If significant differences were found, results were compared by a paired Student's T-test. P<0.05 was chosen as level of significance.

Results

SET Monitoring

The SET monitoring results are shown below.

TABLE 7
SET design and monitoring. Values are presented as mean ± SD (n = 8).

| Step | | | | | Heart | | | Rectal |
|---|---|---|---|---|---|---|---|---|
| SET | Speed | Slope | Duration | | Rate | Lactate | PCV | T° |
| Unit | m · s⁻¹ | % | minutes | Dataset | Beats/min | Mmol · L⁻¹ | % | ° C. |
| Walk | 1.7 | 0 | 5 | all | NA | NA | NA | NA |
| Trot | 3.5 | 0 | 5 | all | NA | NA | NA | NA |
| Gallop 1 | 8 | 4 | 2 | A | 186 ± 11 | 7.7 ± 3.1 | NA | NA |
| | | | | B | 181 ± 13 | 7.0 ± 3.7 | NA | NA |
| | | | | D | 180 ± 16 | 8.3 ± 4.1 | NA | NA |
| Trot | 3.5 | 0 | 8 | all | NA | NA | NA | NA |
| Gallop 2 | 9 | 4 | 2 | A | 196 ± 11 | 9.7 ± 2.3 | NA | NA |
| | | | | B | 192 ± 13 | 9.5 ± 3.3 | NA | NA |
| | | | | D | 192 ± 15 | 10.3 ± 3.8 | NA | NA |
| Trot | 3.5 | 0 | 8 | all | NA | NA | NA | NA |
| Gallop 3 | 10 | 4 | 2 | A | 211 ± 9 | 14.3 ± 3.0 | NA | NA |
| | | | | B | 204 ± 12 | 13.6 ± 2.3 | NA | NA |
| | | | | D | 210 ± 16 | 16.3 ± 2.3 [symbol] | NA | NA |
| Walk | 1.7 | 0 | 10 | all | NA | NA | NA | NA |
| SET | 0 | 0 | 0 | A | NA | NA | 48.1 ± 5.5 | 39.6 ± 0.4 |
| end | | | | B | NA | NA | 47.4 ± 5.7 | 39.6 ± 0.4 |
| | | | | D | NA | NA | 48.1 ± 6.0 | 39.7 ± 0.6 |

[symbol]

significantly higher than B-value (Anova-1, P < 0.05).
A: mean of data recorded prior to commencement of either food supplement A or pellet B treatment
B: data recorded after food supplement A treatment
D: data recorded after pellet B treatment
PCV: packed cell volume,
NA: not assessed.

All mean values of heart rate, venous lactate, PCV and rectal body temperature recorded after food supplement A supplementation (B) showed a trend to be lower than those assessed before treatment (A) and after pellet B supplementation (D). Mean venous lactate recorded at the end of the third gallop of protocol B was significantly lower than that recorded at D, but difference with A was not significant.

Blood Markers

Pooled (R, Eₘₐₓ, E₁₅, E₆₀) plasma uric acid levels were significantly lower after food supplement A treatment (B) when compared with pre-treatment (A, P<0.02) and with pellet B (D, P<0.005).

There was a trend for haemolysate TGSH (GSH+GSSG) concentrations to be higher after food supplement A treatment (B). The E₆₀ GSH increase was more pronounced after food supplement A administration (B). Haemolysate GRR remained unchanged after treatment or exercise.

8-Epi-PGF_{2α} was not modified by either food supplement A (B) or pellet B (D).

Pulmonary Markers

By correcting the dilution of the BAL fluid by the urea method the concentrations of BAL uric acid, glutathione and 8-epi-PGF_{2α} were expressed per ml of pulmonary epithelial lining fluid (PELF).

Uric acid concentrations in PELF were not affected by food supplement A treatment, neither at rest, nor after the SET.

Total glutathione levels (GSH+GSSG) in PELF were not significantly affected by food supplement A or pellet B. Exercise-induced decrease of PELF GSH was not significant, but less pronounced in B (food supplement A). Glutathione redox ratio remained unchanged.

Bronchoalveolar Lavage Differential Cell Count and Endoscopic Inflammatory Score

Resting (R) differential cell counts of BAL performed at A, B and C and respective resting (R) and post-exercise (E₆₀) endoscopic inflammatory scores are below.

TABLE 8
BAL differential cell count and endoscopic
inflammatory score. Values are presented as
mean ± SD (n = 8).

| | Dataset | | |
|---|---|---|---|
| Variable | A | B | D |
| BAL differential | | | |
| cell count | | | |
| % Macrophages | 38.8 ± 11.8 | 43.0 ± 5.6 | 42.6 ± 16.9 |
| % Lymphocytes | 45.8 ± 12.3 | 42.5 ± 12.1 | 38.9 ± 20.5 |
| % Neutrophils | 13.3 ± 17.0 | 13.4 ± 11.2 | 13.9 ± 12.8 |
| % Epithelial cells | 0.7 ± 1.6 | 1.9 ± 1.1 | 1.9 ± 3.2 |
| Inflammatory score | | | |
| Rest | 4.38 ± 0.52 [symbol] | 3.63 ± 0.52 | 4.50 ± 0.54 [symbol] |
| Post-exercise E₆₀ | 5.13 ± 0.99 [symbol] | 4.13 ± 0.84 | 4.5 ± 0.54 |

[symbol]

significantly higher than B-value (Anova-1, P < 0.05).
A: mean of data recorded prior to commencement of either food supplement A or pellet B treatment (n = 8)
B: data recorded after food supplement A treatment (n = 8)
D: data recorded after pellet B treatment (n = 8)

Bronchoalveolar differential cell count was influenced neither by food supplement A (B) nor by pellet B (D).

Resting endoscopic score was significantly lower after food supplement A treatment (B) when compared with pre-treatment values (A) and with pellet B-values (D). Post-exercise scores were non significantly increased in A, B and D. The pre-treatment score (A) was significantly higher than in B.

In summary, this study has shown that oral antioxidant supplementation may have a beneficial effect on lung function of COPD-affected horses in clinical remission.

Enhanced exercise tolerance, reduction of endoscopic inflammatory score and downregulation of the systemic XDH and XO-pathway with subsequent decreased uric acid synthesis were significant findings in the current study. Pulmonary function tests, BAL cytology, PELF uric acid and PELF 8-epi PCF_{2α} were not influenced by the anti-oxidant supplement treatment but there was a trend towards enhanced systemic and pulmonary GSH restoration after exercise.

### EXAMPLE 2

Determination of the Effect of One Component of the Food Supplement (Ascorbic Acid) on Ascorbic Acid Concentrations in Plasma and Bronchoalveolar Lavage.

This study was carried out using 14 horses; 4 healthy horses and 10 horses suffering from COPD in clinical remission. All horses had been kept continuously on grass for at least 2 months.

Ascorbic acid in bronchoalveolar lavage and plasma were analysed by HPLC using electrochemical detection and UV detection respectively. Bronchoalveolar lavage concentrations of ascorbic acid were corrected to mmol.l⁻¹ of epithelial lining fluid using plasma and bronchoalveolar lavage urea concentrations.

TABLE 9

| | Healthy horses | COPD horses | |
|---|---|---|---|
| | (n = 4) | (n = 10) | |
| Plasma ascorbic acid | 11.2 ± 0.7 | 8.0 ± 2.6 | P = 0.002 |
| (micromol/l) | | | |
| Bronchoalveolar lavage | 13.1 ± 4.0 | 2.1 ± 1.4 | P = 0.013 |
| ascorbic acid (micromol/l) | | | |
| Epithelial lining fluid | 3.0 ± 1.9 | 0.2 ± 0.1 | P = 0.06 |
| ascorbic acid (micromol/l) | | | |

These results indicate that ascorbic acid is present in the bronchoalveolar lavage and plasma of healthy horses and horses suffering from COPD. The concentration of ascorbic acid in horses suffering from COPD is lower than that in healthy horses.

The concentration of ascorbic acid in epithelial lining fluid of healthy horses is 20-30 times greater than those of reduced glutathione previously reported in horses. Thus it appears that ascorbic acid is a major antioxidant in equine lung fluid lining and horses suffering from COPD appear to have markedly reduced levels in both plasma and bronchoalveolar lavage. COPD horses have shown reduced levels of other antioxidants such as glutathione.

### EXAMPLE 3

Measurement of Vitamin C Levels in Epithelial Lining Fluid.

Six healthy ponies free of respiratory disease on the basis of endoscopy of the respiratory tract and cytological and bacteriological analysis of tracheal wash and bronchoalveolar lavage (BAL) were studied in a 3×3 Latin square design. Ponies were stabled in pairs and fed a diet of haylage to maintain bodyweight and condition. The ponies were allowed access to paddocks whilst muzzled for part of each day.

Ponies were studied in stable pairs and each pair received three treatments: 1)—Control (C); 2) Ascorbyl palmitate (AP; fed at 57.1 mg/day per kg BW); 3) Stabilised ascorbic acid (STAY-C; fed at 57.1 mg/day per kg BW). Doses were chosen to ensure equivalent ascorbic acid levels. Each treatment lasted two weeks and was followed by a washout period of two weeks before the next treatment period. Every two weeks BAL was performed in the right and left lung. On the day following BAL, blood samples were collected before and every hour following feeding up to 8 hours to determine plasma bioavailability.

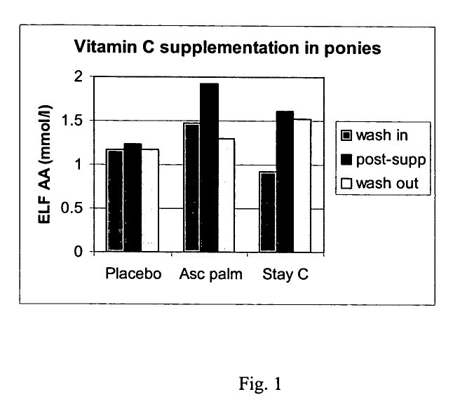

Both AP and Stay-C produced elevations in plasma ascorbic acid concentration similar to those reported previously in the literature. Peak plasma ascorbic acid concentrations following feeding of AP or Stay-C were seen at around 6-8 hours post-feeding. There was no change in plasma ascorbic acid over the corresponding period in the control treatment. Both forms of vitamin C also result in increased levels of ascorbic acid in the epithelial lining fluid. These results are illustrated in FIG. 1 which indicates the effects of ascorbic acid supplementation on the concentration of ascorbic acid in the epithelial lining fluid.

### EXAMPLE 4

Determination of the Effect of the Food Supplement on Ascorbic Acid Concentrations in Plasma and Bronchoalveolar Lavage.

This study was carried out using a food supplement of the following composition.

TABLE 10

| Ingredient | Percentage (by weight) |
|---|---|
| Oat or Wheat Feed | 60%-2% |
| Maize Gluten | 50%-2% |
| Soya Bean Hulls | 30%-2% |
| Brewers Yeast | 10%-1% |
| Dried Spinach | 10%-1% |
| Dried Kale or Dried Broccoli | 10%-1% |
| Molasses | 10%-1% |
| Vitamin C | 12%-0.02% |
| Alpha Tocopherol Acetate | 4%-0.2% |
| Dried Garlic | 6%-0.05% |
| Dried Nutmeg | 6%-0.05% |
| Dried Rosemary | 6%-0.05% |
| Grape Seed Oil | 3%-0.05% |
| Folic acid | 0.1-0.0002% |
| Sodium Selenite | 0.02-0.0002% |
| Red Palm Oil | 10%-1% |

Five healthy horses free of respiratory disease on the basis of clinical examination and cytological and bacteriological analysis of tracheal wash (TW) and bronchoalveolar lavage (BAL) were studied. They were stabled, bedded on paper and fed a commercial mix and haylage to maintain bodyweight and condition. Prior to the start of the study, the horses performed an incremental exercise test to determine maximum oxygen uptake (VO2max). Throughout the study the horses were exercised three times per week for two minutes at 90% VO2max. Each horse received two treatments in a Latin square design: 1) food supplement, 2) Placebo supplement. Each treatment was given for four weeks and was followed by washout period of our weeks before the next treatment period. Three days prior to the end of each period TW and BAL were performed, the latter in the right lung. On the final day of each period the horses performed an exercise test on a 3 incline with the following protocol: 10 min at 1.7 m/s, 5 min at 3.7 m/s, 2 min at 70% VO2max, 5 min at 1.7 m/s, 2 min at 80% VO2max, 5 min at 1.7 m/s and 2 min at 90% VO2max. Venous blood samples were taken prior to and 60 minutes post exercise. BAL was performed one hour post exercise. Plasma and BAL samples were analysed for ascorbic acid (AA). BAL fluid samples were calculated to give epithelial lining fluid (ELF) concentrations using the urea dilution method. Antioxidant supplementation caused a significant increase in the concentration of plasma AA at rest compared to the pre-supplementation period (p=0.003; 26.2 3.4 mol/l and 19.2 3.7 mol/l respectively) but there was no effect of placebo (p>0.05; 19.8 6.9 mol/l versus 19.2 3.7mol/l). Resting ELF AA concentration increased following antioxidant supplementation compared to the pre-supplementation period but not significantly (p=0.076; 1.7 *0.8 mmol/l and w.3 *0.5 mmol/l respectively). The placebo supplement did not alter ELF AA (1.2 1.1 mmol/l versus 1.3 *0.5 mmol/l). Neither plasma nor ELF AA were significantly changed one hour after the exercise test compared to resting concentrations after either the antioxidant supplement or the placebo. In summary, antioxidant supplementation caused increases in plasma levels of ascorbic acid and in ELF ascorbic acid levels.

1 a food supplement comprising one or more antioxidant vitamin with one or more of eugenol, a flavenoid, a phyto-estrogen, a proanthrocyandin, selenium or ubiquinone, a carotenoid or a herbal phenolic.

2 A food supplement as claimed in claim 1 wherein the antioxidant vitamin is one or more of vitamin C, vitamin E or beta-carotene.

3 A food supplement as claimed in claim 1 or claim 2 further comprising a B vitamin.

4 A food supplement as claimed in claim 3 wherein the B vitamin is one or more of vitamin B-1, vitamin B-2, vitamin B-3, vitamin B-6, vitamin B-12, pantotheic acid or folate.

5 A food supplement as claimed in anyone of claims 1 to 4 further comprising one or more trace element.

6 A food supplement as claimed in claim 5 wherein the trace element is one or more of iron, zinc, copper, magnesium, manganese or calcium.

7 A food supplement as claimed in any one of claims 1 to 6 which provides a concentration of vitamin E at a level of 5 IU per kilogram body weight per day or above.

8 A food supplement as claimed in any one of claims 1 to 7 which provides a concentration of vitamin C at a level of 10 mg per kilogram body weight per day or above.

9 A food supplement as claimed in any one of claims 1 to 8 which provides a concentration of beta-carotene at a level of 0.3 mg per kilogram body weight per day or above.

10 A food supplement as claimed in any one of claims 1 to 9 which provides a concentration of selenium at a level of 0.002 mg per kilogram body weight per day or above.

11 A food supplement as claimed in anyone of claims 1 to 10 which provides a concentration of ubiquinone at a level of 0.5 mg per kilogram body weight per day or above.

12 A food supplement as claimed in any one of claims 1 to 11 which provides a concentration of folate at a level of 0.02 mg per kilogram body weight per day or above.

13 A food supplement wherein each component of the food supplement as set out in anyone of claims 1 to 12 is provided by a synthetic source or a natural source.

14 A food supplement as claimed in anyone of claims 1 to 13 wherein a portion of the antioxidant vitamin is provided by a natural source and a portion of the antioxidant vitamin is provided by a synthetic source.

15 A food supplement as claimed in any one of claims 1 to 14 wherein one or more of eugenol, a flavenoid, a phyto-estrogen, a proanthrocyandin, a carotenoid, a herbal phenolic, selenium or ubiquinone is provided by a natural source and a synthetic source.

16 A food supplement as claimed in anyone of claims 1 to 15 wherein vitamin C is provided as Stay-C or ascorbyl palmitate.

17 A food supplement as claimed in anyone of claims 1 to 16 wherein vitamin E is provided as alpha-tocopherol or alpha-tocopherol acetate.

18 A food supplement as claimed in any one of claims 1 to 17 wherein part of vitamin C or vitamin E is provided by one or more of broccoli, spinach, cabbage, cauliflower, brussel sprouts, kale or chard.

19 A food supplement as claimed in claim 17 wherein the source of vitamin C or vitamin E is raw, cooked, or dried material.

20 A food supplement as claimed in any one of claims 1 to 19 which provides a concentration of broccoli at a level of 20 mg per kilogram body weight per day or above.

21 A food supplement as claimed in any one of claims 1 to 20 which provides a concentration of spinach at a level of 20 mg per kilogram body weight per day or above.

22 A food supplement as claimed in anyone of claims 1 to 21 wherein one or more of caretonoids or vitamin E is provided by red palm oil.

23 A food supplement as claimed in anyone of claims 1 to 22 wherein a phyto-estrogen is provided by one or more of broccoli, spinach, cabbage, cauliflower, brussel sprouts, kale or chard.

24 A food supplement as claimed in anyone of claims 1 to 23 wherein eugenol is provided by one or more of garlic, cloves or nutmeg.

25 A food supplement as claimed in any one of claims 1 to 24 wherein a flavenoid is provided by one or more of rosemary or liquorice.

26 A food supplement as claimed in any one of claims 1 to 25 wherein a herbal phenolic is provided by rosemary.

27 A food supplement as claimed in any one of claims 3 to 26 wherein one or more of vitamin E or proanthrocyanidin is provided by grape seed oil.

28 A food supplement as claimed in any one of claims 1 to 26 wherein selenium is provided by sodium selenate.

29 A food supplement as claimed in any one of claims 1 to 28 wherein selenium is provided by one or more of broccoli, spinach, cabbage, cauliflower, brussel sprouts, kale or chard.

30 A food supplement as claimed in claim 3 wherein the B vitamin is provided by one or more of broccoli, spinach, cabbage, cauliflower, brussel sprouts, kale or chard.

31 A food supplement as claimed in claim 3 wherein the B vitamin is provided by Brewers yeast.

32 A food supplement as claimed in claim 31 which provides a concentration of brewers yeast at a level of 20 mg per kilogram body weight per day or above.

33 A food supplement as claimed in anyone of claims 1 to 32 which provides a concentration of eugenol at a level of 0.1 mg per kilogram body weight per day or above.

34 A food supplement as claimed in any one of claims 1 to 33 for use in achieving a health benefit.

35 A food supplement as claimed in anyone of claims 1 to 34 for use in maintaining or improving the natural defences of the lung.

36 A food supplement as claimed in any one of claims 1 to 34 for use in combination with a conventional therapy for the prevention or treatment of respiratory disease.

37 A food supplement as claimed in any one of claims 1 to 36 for use in aiding the prevention or treatment of oxidative damage.

38 A food supplement as claimed in any one of claims 1 to 37 for use in aiding the prevention or treatment of oxidative damage in the respiratory tract.

39 A food supplement as claimed in any one of claims 1 to 38 for use aiding in the prevention or treatment of respiratory disease.

40 A food supplement as claimed in anyone of claims 1 to 39 for simultaneous, sequential or separate use in aiding the prevention or treatment of respiratory disease.

41 A food supplement for use as claimed in any one of claims 39 or 40 wherein the respiratory disease is chronic obstructive pulmonary disease.

42 A food supplement comprising vitamin C for use in the prevention or treatment of a respiratory disease.

43 A food supplement as claimed in any one of claims 1 to 42 wherein the food supplement is administered to an equine animal.

44 A food supplement as claimed in claim 43 wherein the equine animal is a horse.

45 Use of a food supplement as claimed in any one of claims 1 to 33 for the manufacture of a medicament or food stuff for aiding the prevention or treatment of oxidative damage.

46 Use of a food supplement as claimed in any one of claims 1 to 33 for the manufacture of a medicament or food stuff for aiding the prevention or treatment of respiratory disease.

47 A method of aiding the prevention or treatment of oxidative damage, the method comprising administering to the animal a food supplement as claimed in any one of claims 1 to 33.

48 A method of aiding the prevention or treatment of respiratory disease, the method comprising administering to the animal a food supplement as claimed in any one of claims 1 to 33.

49 A food stuff comprising a food supplement as claimed in claims 1 to 33.

50 A method for making a foodstuff as claimed in claim 49, the method comprising mixing one or more component of the food supplement as claimed in claims 1 to 33 with a conventional food stuff.

51 A food stuff as claimed in claim 49 for use in medicine.

52 A food stuff as claimed in claim 51 wherein the use is aiding the prevention or treatment of a respiratory disease.

53 A food supplement as claimed in any one of claims 1 to 33 or a food stuff as claimed in claim 49 wherein the food supplement or food stuff is administered to an animal as an ergogenic aid.

54 A method of improving or increasing the work production of an animal comprising administering a food supplement as claimed in any one of claims 1 to 33 or a food stuff as claimed in claim 49.

55 A food supplement as claimed in any one of claims 1 to 33 or a food stuff as claimed in claim 49 for use in the preparation of an ergogenic aid.

56 A food supplement as claimed in any one of claims 53 to 55 wherein the animal is an equine animal.
